(19) United States
(12) Patent Application Publication
(10) Pub. No.: US 2014/0314138 A1
(43) Pub. Date: Oct. 23, 2014

(54) BACK CHANNEL ADAPTATION FOR TRANSMISSION UNDER PEAK POWER CONSTRAINTS

(71) Applicant: NVIDIA CORPORATION, Santa Clara, CA (US)

(72) Inventors: Lizhi ZHONG, Sunnyvale, CA (US); Vishnu BALAN, Saratoga, CA (US); Ratnakar DADI, San Jose, CA (US); Gautam BHATIA, Mountain View, CA (US)

(73) Assignee: NVIDIA CORPORATION, Santa Clara, CA (US)

(21) Appl. No.: 13/867,916

(22) Filed: Apr. 22, 2013

(51) Int. Cl. H04L 25/03

(52) U.S. Cl. CPC H04L 25/03038
USPC 375/232

(57) ABSTRACT

A method comprises adapting a first tap weight of an equalizer, wherein a second tap weight of the equalizer is based at least in part on the first tap weight. Adapting the first tap weight further comprises computing a gradient from a data signal, an error signal and a channel pulse response sample. Adapting the first tap weight also comprises filtering the gradient with a loop filter and sending information to a transmitter via a back channel. Adapting the first tap weight further comprises configuring the first tap weight based on the information.

### BACKGROUND OF THE INVENTION

1. Field of the Invention

The present invention generally relates to data transmissions, and, more specifically, to an approach for performing channel equalization training.

2. Description of the Related Art

A typical data connector, such as a peripheral component interface (PCI) or PCI express (PCIe), allows different processing units within a computer system to exchange data with one another. For example, a conventional computer system could include a central processing unit (CPU) that exchanges data with a graphics processing unit (GPU) across a PCIe bus.

When a signal is transmitted across the data connector on a transmission channel, some frequency components may be attenuated more than others, which can make the signal illegible at the receiving end. As transmission speeds get faster, the transmissions can become more prone to errors as the noise effects are more severe. In high-speed transmission channels, the signal quality is critically important. One technique to combat this tendency is to “equalize” the channel so that the frequency domain attributes of the signal at the input end are faithfully reproduced at the output end, resulting in fewer errors. High-speed serial communications protocols like PCIe use equalizers to prepare data signals for transmission.

Equalization can be performed on both the transmit end and the receive end of a channel. For transmit equalization, the signal can be reshaped at the transmit end before the signal is sent to attempt to overcome the distortion that will be introduced by the channel. At the receive end, the signal can be reconditioned to improve the signal quality.

For transmit equalization in PCIe, parameters known as equalization coefficients can be used to tune the transmitter. A typical system may have hundreds of combinations of equalization coefficients, and some of these combinations will produce better equalization results than others. The signal quality is critically important in high-speed transmission channels, so an optimal set of coefficients is crucial to ensure accurate transmissions.

High speed interfaces require these parameters to be automatically adapted based on the interface to have sufficient performance. Adjustments can be computed in the receiver and communicated to the transmitter via a back channel. Existing back channel adaptation schemes assume that the different transmission taps are adjusted independently. However, in systems subject to peak power constraints the taps cannot be adjusted independently. Multiple cursor tap weights have to be considered when adjusting the tap weights.

Accordingly, what is needed in the art is a technique that adjusts transmission tap weights when the tap weights are subject to peak amplitude or power constraints.

### SUMMARY OF THE INVENTION

One embodiment of the present invention comprises adapting a first tap weight of an equalizer, wherein a second tap weight of the equalizer is based at least in part on the first tap weight. Adapting the first tap weight further comprises computing a gradient from a data signal, an error signal and a channel pulse response sample. Adapting the first tap weight also comprises filtering the gradient with a loop filter and sending information to a transmitter via a back channel. Adapting the first tap weight further comprises configuring the first tap weight based on the information.

Advantageously, selecting equalization coefficients using the above techniques allows for selection of coefficients that meet the quality criteria required by the system and that remain subject to the peak amplitude or power constraints. In addition, systems subject to peak power constraints may result in lower power consumption than other systems.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3 is a conventional illustration of transmitted signals and received signals;

FIG. 4 is a conventional illustration of transmitted data and received data that results in errors;

FIG. 5 is an illustration of signals at the receive end before and after equalization according to one embodiment of the present invention;

FIG. 6A is an illustration of a system utilizing a back channel adaptation scheme;

FIG. 6B is an illustration of transmitters utilizing back channel adaptation schemes;

FIG. 6C is an illustration of adaptation loops utilizing back channel adaptation schemes;

FIG. 6D is an illustration of an implementation of a back channel adaptation scheme;

FIG. 7 is an illustration of a pulse for a particular bit;

FIG. 8 is an example of a transmission finite impulse response (FIR) filter with one precursor tap;

FIG. 9 is an example of a transmission FIR filter with one post cursor tap;

FIG. 10 is an example of a transmission FIR filter with one precursor tap and one post cursor tap;

FIG. 11 is an example of a two-tap decision feedback equalizer (DFE); and

FIG. 12 is a flowchart illustrating an example technique for performing channel equalization according to one embodiment of the present disclosure.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

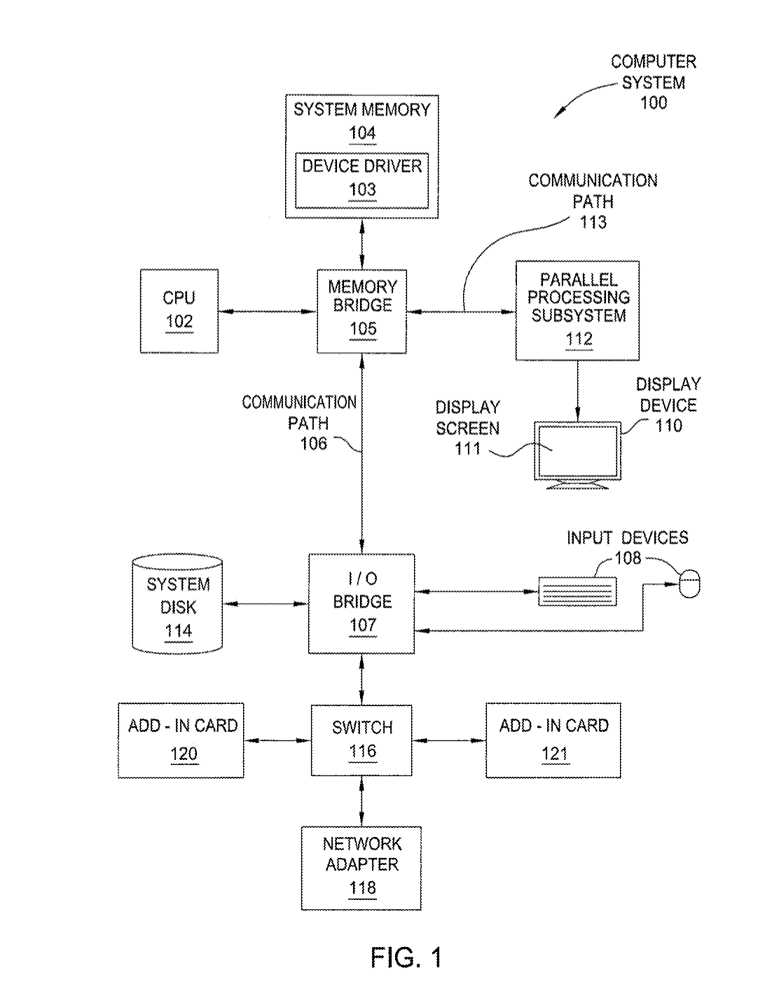

FIG. 1 is a block diagram illustrating a computer system 100 configured to implement one or more aspects of the present invention. Computer system 100 includes a central processing unit (CPU) 102 and a system memory 104 that includes a device driver 103. CPU 102 and system memory 104 communicate via an interconnection path that may include a memory bridge 105. Memory bridge 105, which may be, e.g., a Northbridge chip, is connected via a bus or other communication path 106 (e.g., a HyperTransport link) to an input/output (I/O) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a peripheral component interconnect (PCI) express, Accelerated Graphics Port (AGP), or HyperTransport link); in one embodiment parallel processing subsystem 112 is a graphics subsystem that delivers pixels to a display device 110 (e.g., a conventional cathode ray tube (CRT) or liquid crystal display (LCD) based monitor). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) or other port connections, compact disc (CD) drives, digital video disc (DVD) drives, film recording devices, and the like, may also be connected to I/O bridge 107. Communication paths interconnecting the various components in FIG. 1 may be implemented using any suitable protocols, such as PCI, PCI Express (PCIe), AGP, HyperTransport, or any other bus or point-to-point communication protocol(s), and connections between different devices may use different protocols as is known in the art. Although not explicitly shown, communication links can be between a GPU and its dedicated memory, between a GPU and one or more other GPUs, between a GPU and a display, and/or between a CPU and various peripherals (e.g., PCI Express and USB).

PPU 112 is configured to execute a software application, such as e.g. device driver 103, that allows PPU 112 to generate arbitrary packet types that can be transmitted across communication path 113. Those packet types are specified by the communication protocol used by communication path 113. In situations where a new packet type is introduced into the communication protocol (e.g., due to an enhancement to the communication protocol), PPU 112 can be configured to generate packets based on the new packet type and to exchange data with CPU 102 (or other processing units) across communication path 113 using the new packet type.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

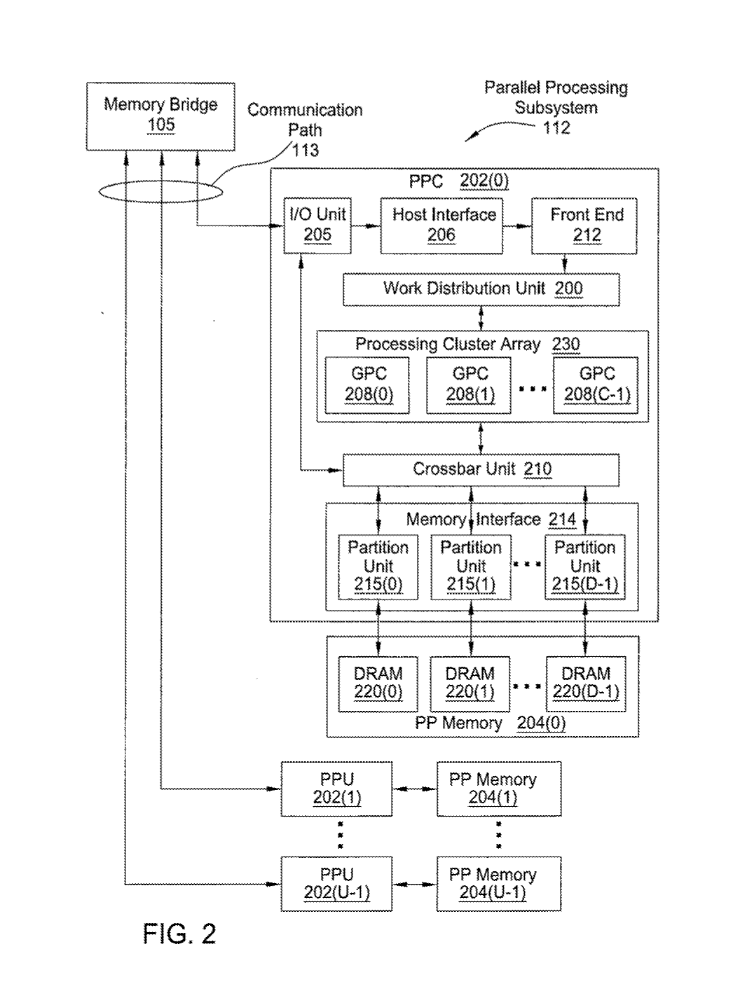

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer (not explicitly shown in either FIG. 1 or FIG. 2) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2, each PPU 202 includes an I/O unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCIe link, in which dedicated lanes are allocated to each PPU 202, as is known in the art. Other communication paths may also be used. As mentioned above, the contraflow interconnect may also be used to implement the communication path 113, as well as any other communication path within the computer system 100, CPU 102, or PPU 202. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212. Although not explicitly shown, communication links can be between a GPU and its dedicated memory, between a GPU and one or more other GPUs, between a GPU and a display, and/or between a CPU and various peripherals (e.g., PCI Express and USB).

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that dynamic random access memories (DRAMs) 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCIe) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

Back Channel Adaptation for Transmission Under Peak Power Constraints

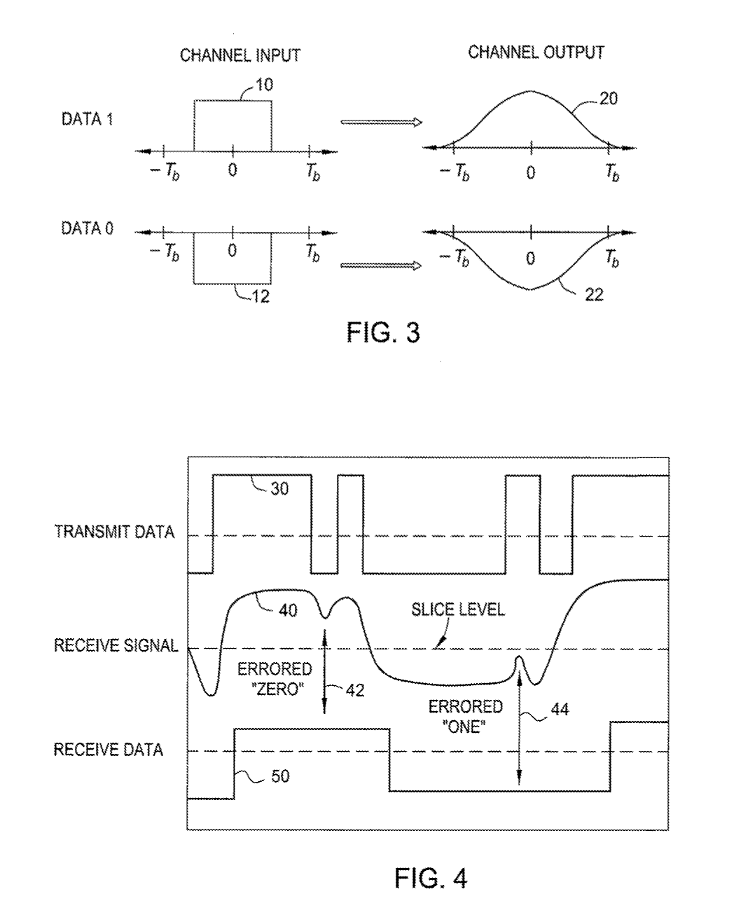

FIG. 3 is a conventional illustration of transmitted signals and received signals. In a computer system, signals can be transmitted in the forms of 1s and 0s along wires to their destination. The signals can degrade as they travel over a channel, so at the destination it may be hard to determine whether the received bit is a 1 or a 0. Input signal 10 represents a data 1 at the transmission end of a channel. Input signal 10 comprises a pulse width of approximately T_{b}. Input signal 12 represents a data 0 at the transmission end of the channel. Input signal 12 also comprises a pulse width of approximately T_{b}. Input signals 10 and 12 appear sharp, like step functions.

The right side of FIG. 3 illustrates two output signals at the receive end of the channel. Output signal 20 comprises a received data 1, and output signal 22 comprises a received data 0. These output signals are distorted due to intersymbol interference (ISI) and thus the output signals do not exactly match the sharp look of input signals 10 and 12. If the distortion becomes too great at the receive end, a 1 could be mistaken for a 0 (or vice versa) and an error would be introduced in the transmission.

FIG. 4 is a conventional illustration of transmitted data and received data that results in errors. Transmit data at a channel input is represented by waveform 30. Waveform 30 comprises a series of 1s and 0s transmitted on a channel. Waveform 30 appears sharp, with clear transitions between 1s and 0s. The dotted line represents a slice level, which marks the boundary between a data 1 and a data 0. Waveform 40 is a representation of the signal at the receive end. Because of interference in the channel, the received signal can be distorted and does not appear as sharp as the transmitted data represented by waveform 30. Waveform 50 is a representation of the data in waveform 40. In other words, when waveform 40 is converted to 1s and 0s the result is waveform 50. As shown in FIG. 4, waveform 50 (the received data) does not exactly match waveform 30 (the transmitted data). Errors were introduced in the transmission. An errored zero 42 is shown, which means a 0 was transmitted but the receiver received a 1. An errored one 44 is also shown, where a 1 was transmitted but the receiver received a 0. When data switches quickly between 1s and 0s, as shown in waveform 30, some of the transitions may be lost due to interference in the received signal (waveform 40), resulting in errors (such as errors 42 and 44) in the received data (waveform 50). As data connections and data transmissions become faster, these types of errors become more common because the received signals do not have enough time to fully transition from a 1 to a 0 or vice versa. Equalization can be performed to help prevent these errors.

In PCI Express Gen 3, equalization comprises implementing settings that compensate for ISI to make the received signal look like the original transmitted signal. Both transmission and receive equalization may be performed. In transmission equalization, the signal at the transmit end is “reshaped” before the signal is sent, in a manner that is complementary to the distortion that will be introduced by the channel. In other words, the reshaping can counteract the distortion. Reshaping can allow the receive end to more easily differentiate between 1s and 0s. In receive equalization, the signal is reconditioned at the receive end to counter the distortion introduced by the channel and further improve the signal quality. In PCI Express Gen 3, both transmission and receive equalization can be performed.

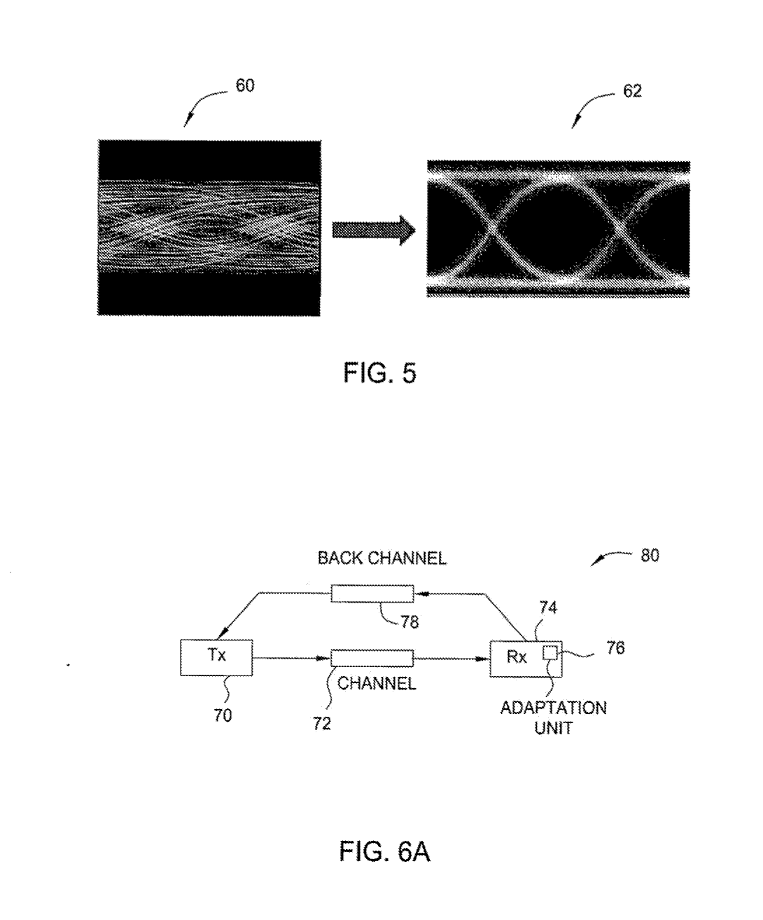

FIG. 5 illustrates one example of signals at the receive end of a transmission before and after equalization according to one embodiment of the present invention. The signals shown in waveform 60 have not had equalization performed on them. The signals shown in waveform 62 illustrate signals after equalization. The transitions between 1s and 0s can more be seen more clearly in waveform 62 than in waveform 60 due to equalization.

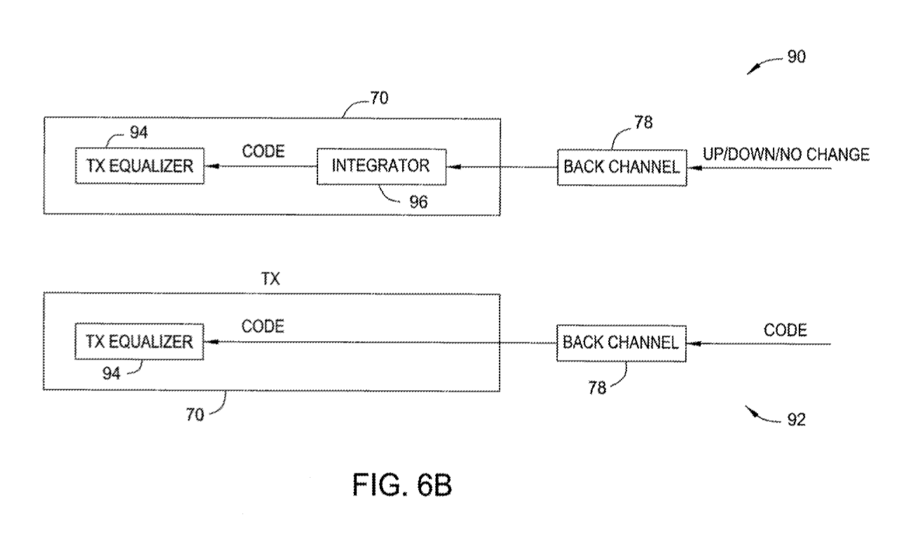

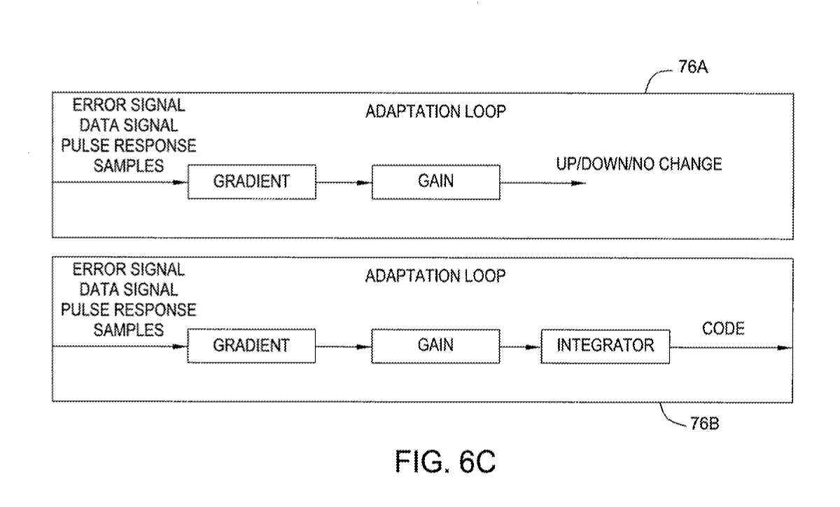

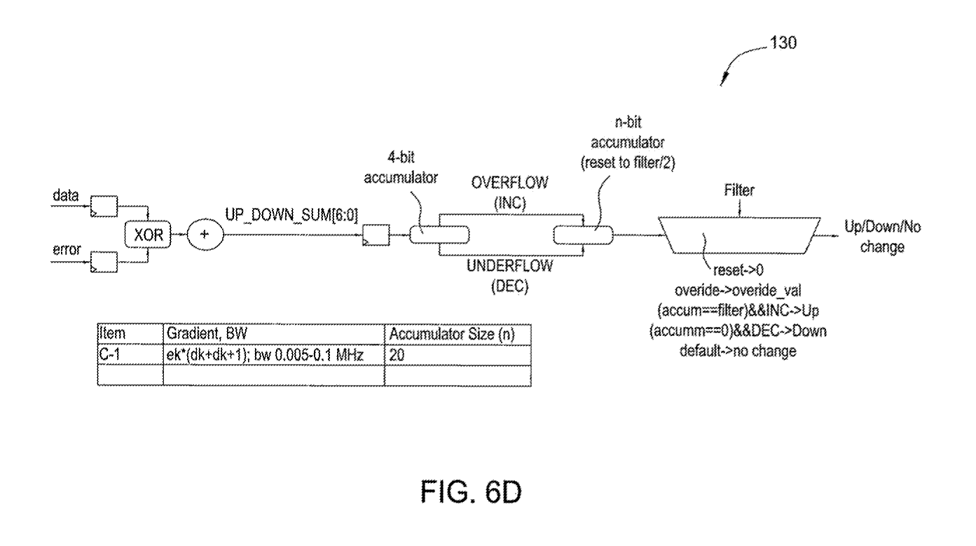

FIG. 6A is an example embodiment of a system 80 utilizing a back channel adaptation scheme. System 80 can be employed in systems or subsystems such as those illustrated in FIGS. 1 and 2. System 80 comprises a transmitter 70 and a receiver 74. Transmissions can be sent across channel 72 from transmitter 70 to receiver 74. Adjustments to the transmission tap weights can be performed for channel equalization. These adjustments can be computed in the receiver 74 by adaptation unit 76 and transmitted back to the transmitter 70 via back channel 78. The adjustments to the transmission tap weights may be correlated in certain embodiments. For example, in systems subject to peak power or peak amplitude constraints, the tap weights are correlated, and any adjustments made to the tap weights must be made accordingly. Adaptation unit 76 can develop the adjustments to the tap weights subject to the constraints in the system. In some example embodiments, the peak amplitude between two tap weights should remain the same before and after the adjustment or adaptation of the tap weights. In other example embodiments, the sum of the absolute values of the tap weights should be a constant, and therefore an adjustment to one or more of the tap weights sometimes requires an adjustment to one or more of the other tap weights to maintain the constant sum.

FIG. 68 illustrates example embodiments of a transmitter utilizing a back channel adaptation scheme. In subsystem 90, a signal travels via back channel 78 that contains a gradient to signal a move within a lookup table. As described in further detail below, a channel can have three parameters: a precursor, post cursor, and main cursor, and each parameter has an associated lookup table. The gradient computed for each parameter informs the system to move up, move down, or stay at the same spot in the lookup table. Integrator 96 within transmitter 70 can receive a signal from the back channel and compute a code to send to the transmit equalizer 94 which can adjust one or more parameters or leave them the same. In another example embodiment exemplified by subsystem 92, code is transmitted across back channel 78 to transmit equalizer 94 to adjust one or more parameters or leave them the same.

FIG. 6C illustrates example embodiments of adaptation loops in a back channel adaptation scheme. The first example adaptation loop 76A includes inputs such as error signals, data signals, and pulse response samples that can be used to compute a gradient. The gradient can be used to determine whether to move up, move down, or stay at the same spot in the lookup table. A gain block can also be utilized. The second example adaptation loop 76B also includes inputs such as error signals, data signals, and pulse response samples that can be used to compute a gradient. In this example, a gain block and an integrator can be used to compute a code to send across the back channel.

O FIG. 6D illustrates an example implementation 130 of a back channel adaptation scheme. Data signals and error signals can be input and operations can be performed on the inputs as shown. Additional details of the implementation will be discussed below. One end result, as shown, informs the system to move up, move down, or stay at the same spot in the lookup table.

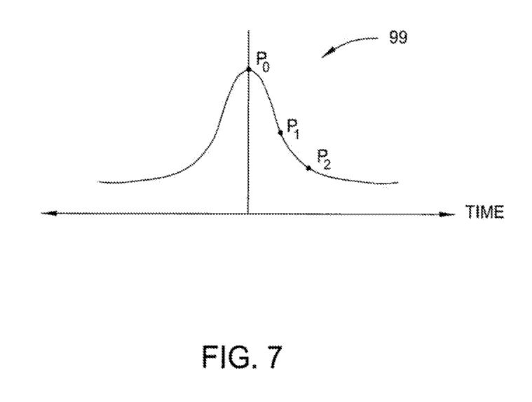

FIG. 7 is an illustration of a pulse 99 according to one embodiment of the present disclosure. Certain points on the pulse, such as P₀, P₁, and P₂, can be used to calculate a gradient which can in turn be used to adjust a tap weight of the transmitter, as described in further detail below. The gradient of the pulse can be used in the precursor, post cursor, and main cursor calculations to select an appropriate adjustment for the tap weights.

A closed-form expression can be used to adjust a tap and minimize the mean-squared error. Computations based on this expression can be performed by embodiments of the present disclosure utilizing hardware and/or software. Various components of the present disclosure can perform the computations. Below is a derivation of expressions that can be used in certain embodiments of the present disclosure. For independent tap control, the expression is:

$$- {e}_{k} \cdot {\sum }_{i = - ∞}^{∞} ( {d}_{k - i} \cdot {p}_{i - l} )$$

where p is the amplitude, k is the k^{th} data bit, eₖ is an error for each k^{th} bit (i.e., the difference between the ideal and the actual signal received), and d is the data bit. For transmissions with peak power or peak amplitude constraints (i.e., the taps are dependent on one another), the expression is:

$$- {e}_{k} \cdot {\sum }_{i = - ∞}^{∞} [ ( {p}_{i - l} + {p}_{i} ) \cdot {d}_{k - i}$$

As seen, the expression utilizes the amplitudes of multiple values of p (in this case, pᵢ₋ₗ and pᵢ. For the latch input:

$${r}_{k} = {\sum }_{i = - ∞}^{∞} {\sum }_{l = - {L}_{1}}^{{L}_{2}} ( {c}_{l} \cdot {p}_{i - 1} \cdot {d}_{k - i} )$$

pᵢ₋ₗ denotes the pulse response samples of the link between the TXFIR output and the latch input (including the channels and the RX equalizers).

A peak power constraint can be computed with the expression:

$${\sum }_{l = - {L}_{1}}^{{L}_{2}} \vert {c}_{l} \vert = M$$

where M is the peak amplitude.

The value of the summation determines whether to increase, decrease, or keep the tap weight the same. A channel can have three parameters: a precursor, post cursor, and main cursor. Each parameter has an associated lookup table. The gradient computed for each parameter informs the system to move up, move down, or stay at the same spot in the lookup table. These adjustments can continue over multiple transmissions to perform equalization on the channel. The expressions described above will adjust the tap weights while also respecting the peak power constraint.

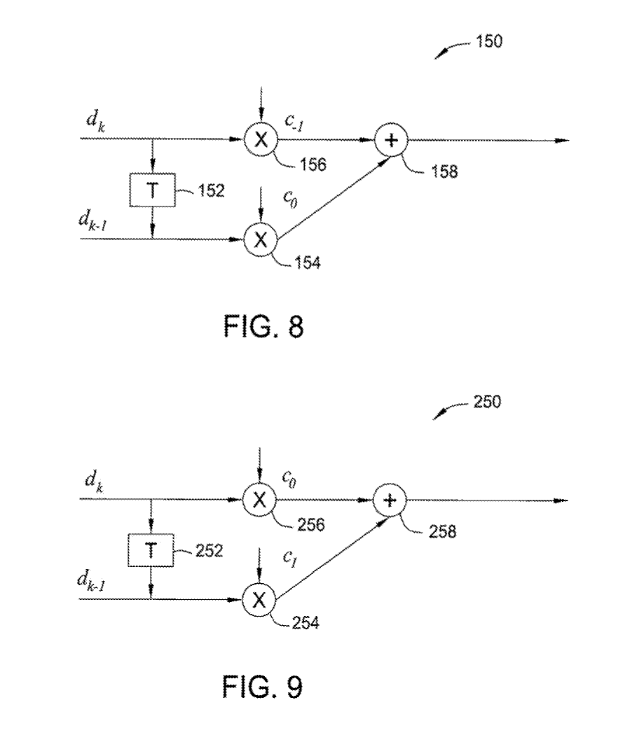

FIG. 8 is an example of a transmission FIR filter 150 with one precursor tap 152. Filter 150 also comprises multipliers 154 and 156 and adder 158 in this example. The main cursor is represented by c₀, and the precursor is represented by c₋₁. The values of the tap coefficients c₀ and c₋₁ are selected from one or more lookup tables in a manner as described above.

FIG. 9 is an example of a transmission FIR filter 250 with one post cursor tap 252. Filter 250 also comprises multipliers 254 and 256 and adder 258 in this example. The main cursor is represented by c₀, and the post cursor is represented by c₁. The values of the tap coefficients c₀ and c₁ are selected from one or more lookup tables in a manner as described above.

In the examples discussed above, if cₗ is negative or zero,

cₗ=−ρ·M, l=1 or −1

c₀=(1−ρ)·M

The algorithm therefore only needs to adapt ρ.

In the first example,

rₖ=Σ_{i=-∞}^{∞}Σᵢ₌₋₁⁰(cₗ·pᵢ₋ₗ·dₖ₋ᵢ=Σ_{i=-∞}^{∞}{[1−ρ)·M·pᵢ−ρ·M·pᵢ₊₁]·dk−i}=i=∞∞{[pi+ρ·(−pi+1−pi)]·M·dk−i}

The error can be defined as:

eₖ=rₖ−h₀·

[symbol]

If we differentiate eₖ² with ρ, the result is:

$$\frac{\partial {e}_{k}^{2}}{\partial ρ} = - 2 \cdot M \cdot {e}_{k} \cdot {\sum }_{i = - ∞}^{∞} [ ( {p}_{i + 1} + {p}_{i} ) \cdot {d}_{k - i} ]$$

The constant factor may be dropped in implementations with adjustable loop bandwidth. Consequently, the gradient is:

$$- {e}_{k} \cdot {\sum }_{i = - ∞}^{∞} [ ( {p}_{i - l} + {p}_{i} ) \cdot {d}_{k - i} ]$$

For the second example, going through similar analysis, one can get:

$$- {e}_{k} \cdot {\sum }_{i = - ∞}^{∞} [ ( {p}_{i - l} + {p}_{i} ) \cdot {d}_{k - i} ]$$

Or more generally,

$$- {e}_{k} \cdot {\sum }_{i = - ∞}^{∞} [ ( {p}_{i - l} + {p}_{i} ) \cdot {d}_{k - i} ]$$

where l=1, −1 or another number associated with the other tap to be adjusted. In certain embodiments, l=1 for the post cursor, 0 for the main cursor, and −1 for the precursor.

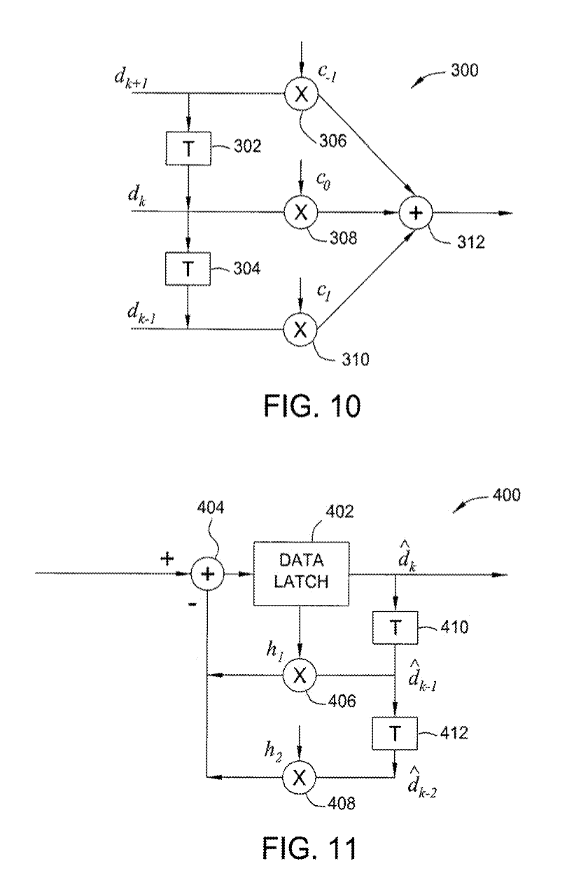

FIG. 10 is an example of a transmission FIR filter 300 with one precursor tap 302 and one post cursor tap 304. Filter 300 also comprises multipliers 306, 308, and 310, and adder 312 in this example embodiment. The main cursor is represented by c₀, the post cursor is represented by c₁, and the precursor is represented by c₋₁. Other example embodiments may include even more taps, such as two precursors and one post cursor or one precursor and two post cursors.

FIG. 11 is an example of a two-tap DFE 400 located on the receive side. DFE 400 comprises a data latch 402, an adder 404, multipliers 406 and 408, and taps 410 and 412. DFE 400 can implement computations as described in this disclosure to adjust the taps for transmission equalization. The variables h1 and h2 can be used by DFE 400 to determine the three points P₀, P₁, and P₂ seen in FIG. 7. With those three points, a gradient can be computed as described by the expressions above. This gradient provides an error value which determines whether to move up, down, or stay at the same point in the lookup table for each coefficient. The values from the lookup table (c₀, c₋₁, and c₁) can then be used for transmission equalization as shown in FIGS. 8-10.

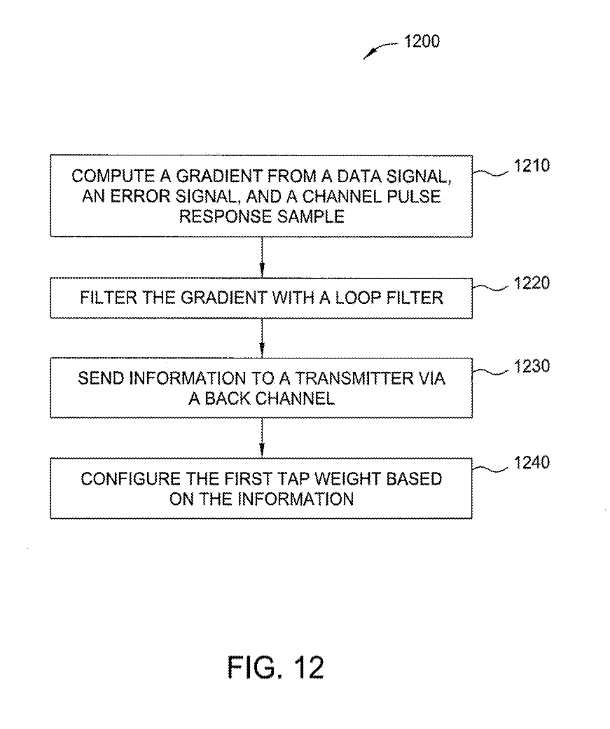

FIG. 12 is a flow diagram of method steps for performing channel equalization according to one embodiment of the present disclosure. In particular, the method adjusts a tap weight of an equalizer. Although the method steps are described in conjunction with FIGS. 1, 2, 6A-6D, and 8-10, persons skilled in the art will understand that any system configured to perform the method steps, in any order, falls within the scope of the present invention. Processing unit 102 is configured to perform the various steps of the method 1200 when executing a software application stored in a memory, such as system memory 104. In some embodiments, parallel processing subsystem 112 may perform some of the steps of the method 1200. In other embodiments, system 80 may perform some or all of the steps of the method 1200.

As shown, a method 1200 begins in step 1210, where a gradient is computed from a data signal, an error signal, and a channel pulse response sample. One example embodiment for computing this gradient is described above. In step 1220, the gradient is filtered with a loop filter. In step 1230, information is sent to a transmitter via a back channel. In some embodiments, the information is computed by one or more units within a receiver and then sent to the transmitter. The information may include, for example, an adjustment to a tap weight. In some embodiments, the information may be derived at least in part from data found in a lookup table. In other embodiments, the information may be a code corresponding to the first tap weight. In step 1240, the first tap weight is configured based on the information.

In summary, a new adaptation algorithm is used to adjust the transmission tap weights when they are subject to peak amplitude or power constraints. A transmitter may comprise one or more transmission taps, which need to be adjusted for equalization but cannot be adjusted independently. The algorithms described above can compute a gradient to adjust the tap weights. The adjustments can be derived from a lookup table. The adjustments can be sent from a receiver to the transmitter via a back channel. Adjustments in accordance with the present disclosure allow the tap weights to converge to the optimal setting in a timely manner while respecting the peak power or amplitude constraints. Advantageously, a system utilizing this algorithm may consume less power than existing systems.

One embodiment of the invention may be implemented as a program product for use with a computer system. The program(s) of the program product define functions of the embodiments (including the techniques described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method for determining equalization coefficients, comprising:
adapting a first tap weight of an equalizer, wherein a second tap weight of the equalizer is based at least in part on the first tap weight.

2. The method of claim 1, wherein the first tap weight is a precursor tap weight, and the second tap weight is a main cursor tap weight.

3. The method of claim 1, wherein the first tap weight is a post cursor tap weight, and the second tap weight is a main cursor tap weight.

4. The method of claim 1, wherein the sum of the absolute value of the first tap weight and the second tap weight remains the same after adapting.

5. The method of claim 1, wherein the equalizer comprises three or more tap weights, and the sum of the absolute values of each of the three or more tap weights is a constant.

6. The method of claim 1, wherein the equalizer is in a transmitter and comprises a finite impulse response (FIR) filter.

7. The method of claim 1, wherein adapting the first tap weight comprises:
computing a gradient from a data signal, an error signal and a channel pulse response sample;
filtering the gradient with a loop filter;
sending information to a transmitter via a back channel; and
configuring the first tap weight based on the information.

8. The method of claim 7, wherein the information is the adjustment to the first tap weight.

9. The method of claim 7, wherein the information is a code corresponding to the first tap weight.

10. The method of claim 7, wherein the channel pulse response sample is approximated by a corresponding tap weight value of a decision feedback equalizer.

11. A computing device, including:
a transmitter; and
a receiver configured to:
adapt a first tap weight of an equalizer, wherein a second tap weight of the equalizer is based at least in part on the first tap weight.

12. The computing device of claim 11, wherein the first tap weight is a precursor tap weight, and the second tap weight is a main cursor tap weight.

13. The computing device of claim 11, wherein the first tap weight is a post cursor tap weight, and the second tap weight is a main cursor tap weight.

14. The computing device of claim 11, wherein the sum of the absolute value of the first tap weight and the second tap weight remains the same after adapting.

15. The computing device of claim 11, wherein the equalizer comprises three or more tap weights, and the sum of the absolute values of each of the three or more tap weights is a constant.

16. The computing device of claim 11, wherein adapting the first tap weight further comprises the steps of:
computing a gradient from a data signal, an error signal and a channel pulse response sample;
filtering the gradient with a loop filter;
sending information to a transmitter via a back channel; and
configuring the first tap weight based on the information.

17. The computing device medium of claim 11, wherein the information is the adjustment to the first tap weight.

18. The computing device of claim 11, wherein the channel pulse response sample is approximated by a corresponding tap weight value of a decision feedback equalizer.

19. An integrated circuit, including:
a transmitter; and
a receiver configured to:
adapt a first tap weight of an equalizer, wherein a second tap weight of the equalizer is based at least in part on the first tap weight.

20. The integrated circuit of claim 19, wherein adapting the first tap weight further comprises the steps of:
computing a gradient from a data signal, an error signal and a channel pulse response sample;
filtering the gradient with a loop filter;
sending information to the transmitter via a back channel; and
configuring the first tap weight based on the information.
